(19) United States
(12) Patent Application Publication
(10) Pub. No.: US 2020/0398646 A1
(43) Pub. Date: Dec. 24, 2020

(54) LIDAR PERMEABLE WINDSHIELD

(71) Applicant: NIO USA, Inc., San Jose, CA (US)

(72) Inventors: Nermin Mujcinovic, Fremont, CA (US); Antonio Antonellis Rufo, San Jose, CA (US)

(21) Appl. No.: 16/449,077

(22) Filed: Jun. 21, 2019

(51) Int. Cl. B60J 1/06; B32B 17/10

(52) U.S. Cl. CPC B60J 1/06; B32B 17/10036; G01S 17/936; B32B 17/10807; B32B 17/10761

(57) ABSTRACT

A laminate glass structure comprising a first glass sheet and a second glass sheet bonded together is provided. The first glass sheet of the laminate glass structure may include tuned light imaging detection and ranging sensor optical transmission characteristics and the second glass sheet may include a void area disposed in a portion thereof. The laminate glass structure can correspond to a laminate vehicle windshield that separates an interior cabin of the vehicle from an exterior of the vehicle. The laminate glass structure allows a light detection and ranging sensor to be mounted inside the interior cabin of the vehicle behind the void area providing a field of view of the sensor that is unobstructed by the second glass sheet. Light emitted and received by the sensor may only pass through the first glass sheet and not the second glass sheet.

### FIELD

The present disclosure is generally directed to vehicle glass structures and, in particular, toward vehicle windshields.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new driving systems.

Driver assist systems are becoming increasingly popular and can assist drivers by monitoring traffic movement, optimizing features such as cruise control, giving lane departure warnings, performing pre-collision braking and blind spot detection. Various imaging systems may be used with such driver assist systems and can be configured to determine an environment surrounding the vehicle.

Traditional light imaging detection and ranging (LIDAR) solutions typically operate by emitting a pulsed laser light toward a target and measuring the reflected light to determine a distance or range to a target. Conventional LIDAR systems have been used in generating detailed three-dimensional maps, including determining a real-time three-dimensional environmental map for air and/or land-based vehicles.

Vehicle manufacturers employing conventional LIDAR systems generally mount the LIDAR system a specific height above the vehicle roof to view a complete periphery around the vehicle. Because safety may be dependent on the unimpeded measurement range of the LIDAR system, vehicle manufacturers typically mount the conventional LIDAR system several feet above the roof of a particular vehicle.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3A is a perspective exploded view of an embodiment of a laminate vehicle windshield in accordance with embodiments of the present disclosure;

FIG. 3B is a perspective view of an embodiment of a laminate vehicle windshield in accordance with embodiments of the present disclosure;

FIG. 4A shows a partial detail section view, taken through line X-X of FIG. 2, of a first portion of a laminate vehicle windshield in accordance with embodiments of the present disclosure;

FIG. 4B shows a partial detail section view, taken through line X-X of FIG. 2, of a second portion of a laminate vehicle windshield in accordance with embodiments of the present disclosure;

FIG. 5A shows a schematic section view, taken through line X-X of FIG. 2, of a laminate vehicle windshield in accordance with embodiments of the present disclosure;

FIG. 5B shows a schematic section view, taken through line X-X of FIG. 2, of a laminate vehicle windshield and a sensor viewing position in accordance with embodiments of the present disclosure;

FIG. 6A shows a schematic plan view of a first embodiment of a void disposed behind a light permeable layer of a vehicle windshield assembly in accordance with embodiments of the present disclosure;

FIG. 6B shows a schematic plan view of a second embodiment of a void disposed behind a light permeable layer of a vehicle windshield assembly in accordance with embodiments of the present disclosure; and

FIG. 6C shows a schematic plan view of a third embodiment of a void disposed behind a light permeable layer of a vehicle windshield assembly in accordance with embodiments of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

Vehicle manufacturers employing conventional Light Imaging, Detection, And Ranging (LIDAR) systems generally mount the LIDAR system a specific height above a vehicle roof to view a complete periphery around the vehicle from a certain distance from the vehicle. This viewing distance may be limited by the mount height of the LIDAR system and any portion of the vehicle that extends into the vertical angular measurement range of the LIDAR system. Because safety may be dependent on the unimpeded measurement range of the LIDAR system, vehicle manufacturers may mount the conventional LIDAR system several feet above the roof of a particular vehicle. As can be appreciated, this functional design requirement limits the aesthetic and even aerodynamic design of a complete vehicle system.

Embodiments of the present disclosure describe a windshield, which may be constructed in such a way that allows for high-performance and long-range LIDAR sensors (and/or imaging systems) to be mounted behind the glass of the windshield. In addition to proper material construction, the windshield angle may be set to allow for operational efficiency and aerodynamics. As described herein, the windshield material may also increase safety.

In some embodiments, the windshield may include a combination safety glass laminate that is modified at an upper center portion to include a cut away section where an alkali-aluminosilicate sheet glass may be disposed, inserted, or fused. This section of sheet glass may provide high scratch-resistance and hardness as well as superior optical transmission characteristics for LIDAR sensors, which may be mounted behind the windshield in this region.

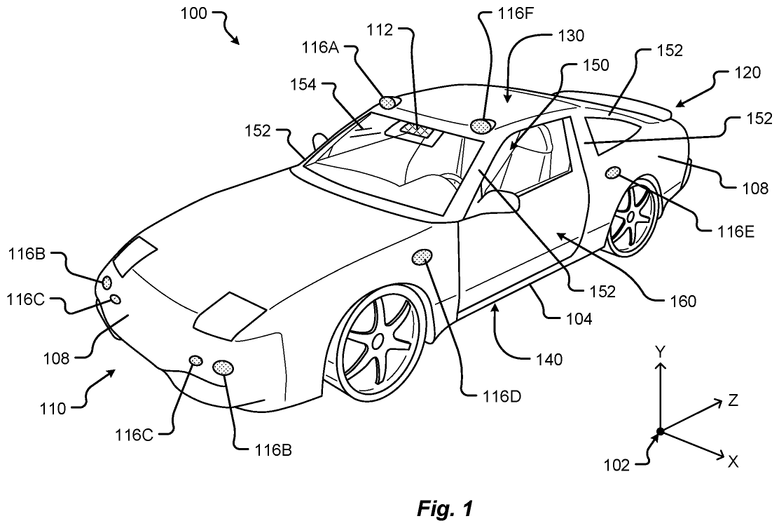

FIG. 1 shows a perspective view of a vehicle 100 in accordance with embodiments of the present disclosure. The electric vehicle 100 comprises a vehicle front 110, vehicle aft or rear 120, vehicle roof 130, at least one vehicle side 160, a vehicle undercarriage 140, and a vehicle interior 150 (e.g., interior cabin, etc.). The vehicle 100 may include a frame 104, or chassis, and one or more body panels 108 mounted or affixed thereto. The vehicle 100 may include one or more interior components (e.g., components inside an interior 150 space, cabin, or user space, of the vehicle 100, etc.), exterior components (e.g., components outside of the interior 150 space, cabin, or user space, of the vehicle 100, etc.), drive systems, controls systems, structural components, etc. The interior 150 cabin of the vehicle 100 may be separated from the exterior of the vehicle 100 by at least one of the body panels 108, windows, and the vehicle windshield 154. In some embodiments, the windshield 154 may comprise a laminate vehicle windshield 154 that is disposed in a portion of the vehicle chassis, or frame 104. The laminate vehicle windshield 154 may be attached to the frame 104 via a support structure that surrounds a periphery of the laminate vehicle windshield 154 and an opening (e.g., a frame) of the vehicle frame 104, or chassis. In some embodiments, the frame 104 may comprise one or more structural elements 152 that provide support to the various components of the vehicle 100. For instance, the structural elements 152 may comprise one or more posts, supports, force distribution bodies, and/or pillars (e.g., A-pillar, B-pillar, C-pillar, and/or D-pillar, etc.) of a vehicle 100. In some cases, one or more of the structural elements 152 may surround a portion, or an entirety, of the laminate vehicle windshield 154 and/or other windows of the vehicle 100. Additionally or alternatively, the structural elements 152 may provide a mount structure for the laminate vehicle windshield 154 as described herein.

In some embodiments, the arrangement of various components of the vehicle 100 may be described with reference to a representative coordinate system 102. The representative coordinate system 102 includes an X-axis, a Y-axis, and a Z-axis, which may be used to define a relationship between components of the vehicle 100, a dimension of components of the vehicle 100, and/or a direction of components, or features of components, of the vehicle 100. For instance, as shown in FIG. 1, the width of the vehicle 100 may be defined as running along the X-axis, the height of the vehicle 100 may be defined as running along the Y-axis, and the length of the vehicle 100 may be defined as running along the Z-axis. Additionally or alternatively, features of the vehicle 100, or other associated objects, may be defined with reference to one or more planes of the representative coordinate system 102. For example, a plane associated with a roadway of the vehicle 100 may be defined as being coincident with the XZ-plane that contacts the tires of the vehicle 100. As another example, the laminate vehicle windshield 154 may lie in, or be at least partially tangential to, a windshield plane that is angled from and intersects the XY-plane and is perpendicular to the YZ-plane. Stated another way, the windshield plane may be a plane that is angled relative to the XY-plane and the XZ-plane of the representative coordinate system 102.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

In some embodiments, the vehicle 100 may include a number of sensors, devices, and/or systems that are capable of assisting in driving operations, e.g., autonomous or semi-autonomous control. Examples of the various sensors and systems may include, but are in no way limited to, one or more of cameras (e.g., independent, stereo, combined image, etc.), infrared (IR) sensors, radio frequency (RF) sensors, ultrasonic sensors (e.g., transducers, transceivers, etc.), radio object-detection and ranging (RADAR) sensors (e.g., object-detection sensors and/or systems), LIDAR systems, odometry sensors and/or devices (e.g., encoders, etc.), orientation sensors (e.g., accelerometers, gyroscopes, magnetometer, etc.), navigation sensors and systems (e.g., GPS, etc.), and other ranging, imaging, and/or object-detecting sensors. In some embodiments, the sensors may be disposed in an interior 150 space, or cabin, of the vehicle 100 and/or on an outside of the vehicle 100. Additionally or alternatively, the sensors and systems may be disposed in one or more portions of the vehicle 100 (e.g., the frame 104, or chassis, a body panel, a compartment, etc.).

The vehicle sensors and systems may be selected and/or configured to suit a level of operation associated with the vehicle 100. Among other things, the number of sensors used in a system may be altered to increase or decrease information available to a vehicle control system (e.g., affecting control capabilities of the vehicle 100). Additionally or alternatively, the sensors and systems may be part of one or more advanced driver assistance systems (ADAS) associated with a vehicle 100. In any event, the sensors and systems may be used to provide driving assistance at any level of operation (e.g., from fully-manual to fully-autonomous operations, etc.) as described herein.

The various levels of vehicle control and/or operation can be described as corresponding to a level of autonomy associated with a vehicle 100 for vehicle driving operations. For instance, at Level 0, or fully-manual driving operations, a driver (e.g., a human driver) may be responsible for all the driving control operations (e.g., steering, accelerating, braking, etc.) associated with the vehicle 100. Level 0 may be referred to as a “No Automation” level. At Level 1, the vehicle 100 may be responsible for a limited number of the driving operations associated with the vehicle 100, while the driver is still responsible for most driving control operations. An example of a Level 1 vehicle 100 may include a vehicle 100 in which the throttle control and/or braking operations may be controlled by the vehicle 100 (e.g., cruise control operations, etc.). Level 1 may be referred to as a “Driver Assistance” level. At Level 2, the vehicle 100 may collect information (e.g., via one or more driving assistance systems, sensors, etc.) about an environment of the vehicle 100 (e.g., an area surrounding the vehicle 100, roadway, traffic, ambient conditions, etc.) and use the collected information to control driving operations (e.g., steering, accelerating, braking, etc.) associated with the vehicle 100. In a Level 2 autonomous vehicle 100, the driver may be required to perform other aspects of driving operations not controlled by the vehicle 100. Level 2 may be referred to as a “Partial Automation” level. It should be appreciated that Levels 0-2 all involve the driver monitoring the driving operations of the vehicle 100.

At Level 3, the driver may be separated from controlling all the driving operations of the vehicle 100 except when the vehicle 100 makes a request for the operator to act or intervene in controlling one or more driving operations. In other words, the driver may be separated from controlling the vehicle 100 unless the driver is required to take over for the vehicle 100. Level 3 may be referred to as a “Conditional Automation” level. At Level 4, the driver may be separated from controlling all the driving operations of the vehicle 100 and the vehicle 100 may control driving operations even when a user fails to respond to a request to intervene. Level 4 may be referred to as a “High Automation” level. At Level 5, the vehicle 100 can control all the driving operations associated with the vehicle 100 in all driving modes. The vehicle 100 in Level 5 may continually monitor traffic, vehicular, roadway, and/or environmental conditions while driving the vehicle 100. In Level 5, there is no human driver interaction required in any driving mode. Accordingly, Level 5 may be referred to as a “Full Automation” level. It should be appreciated that in Levels 3-5, the vehicle 100, and/or one or more automated driving systems associated with the vehicle 100, monitors the driving operations of the vehicle 100 and the driving environment.

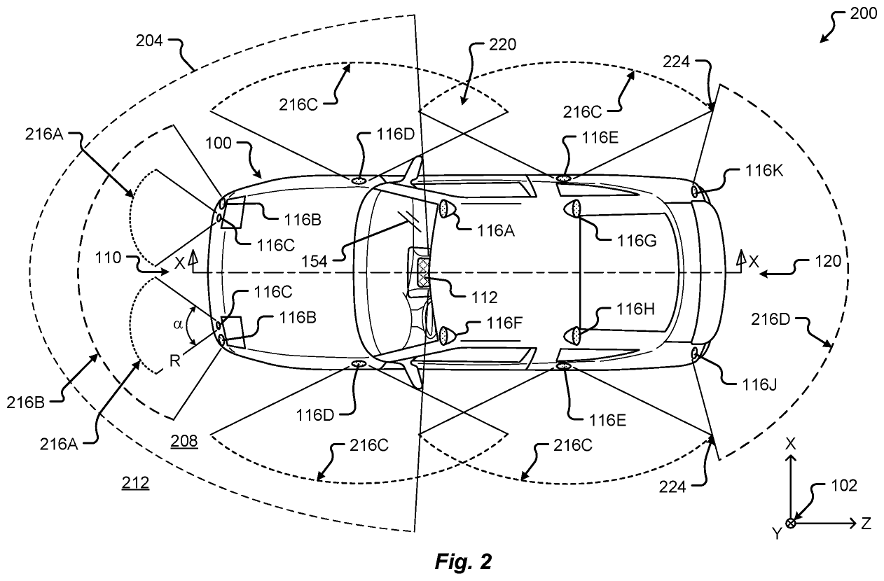

As shown in FIG. 1, the vehicle 100 may, for example, include at least one of a ranging and imaging system 112 (e.g., LIDAR, etc.), an imaging sensor 116A, 116F (e.g., camera, IR, etc.), RADAR system or RF sensors 116B, ultrasonic sensors 116C, and/or other object-detection sensors 116D, 116E. In some embodiments, the LIDAR sensor 112 and/or system may be mounted on a roof 130 of the vehicle 100. As shown in FIG. 1, the LIDAR sensor 112 is shown mounted inside a cabin, or interior 150 space of the vehicle 100 (e.g., behind the vehicle windshield, etc.). In one embodiment, the RADAR sensors 116B may be disposed at least at a front 110, aft 120, or side 160 of the vehicle 100. Among other things, the RADAR sensors may be used to monitor and/or detect a position of other vehicles, pedestrians, and/or other objects near, or proximal to, the vehicle 100. While shown associated with one or more areas of a vehicle 100, it should be appreciated that any of the sensors and systems 116A-K, 112 illustrated in FIGS. 1 and 2 may be disposed in, on, and/or about the vehicle 100 in any position, area, and/or zone of the vehicle 100.

Referring now to FIG. 2, a plan view of a vehicle 100 will be described in accordance with embodiments of the present disclosure. In particular, FIG. 2 shows a vehicle sensing environment 200 at least partially defined by the sensors and systems 116A-K, 112 disposed in, on, and/or about the vehicle 100. Each sensor 116A-K may include an operational detection range, R, and an operational detection angle, a. The operational detection range, R, may define the effective detection limit, or distance, of the sensor 116A-K. In some cases, this effective detection limit may be defined as a distance from a portion of the sensor 116A-K (e.g., a lens, sensing surface, etc.) to a point in space offset from the sensor 116A-K. The effective detection limit may define a distance, beyond which, the sensing capabilities of the sensor 116A-K deteriorate, fail to work, or are unreliable. In some embodiments, the effective detection limit may define a distance, within which, the sensing capabilities of the sensor 116A-K are able to provide accurate and/or reliable detection information. The operational detection angle, a, may define at least one angle of a span, or between horizontal and/or vertical limits, of a sensor 116A-K. As can be appreciated, the operational detection limit and the operational detection angle of a sensor 116A-K together may define the effective detection zone 216A-D (e.g., the effective detection area, and/or volume, etc.) of a sensor 116A-K.

In some embodiments, the vehicle 100 may include a ranging and imaging system 112, such as one or more LIDAR sensors and associated hardware, or the like. The LIDAR sensor 112 may be configured to detect visual information in an environment surrounding at least a portion of the vehicle 100. The visual information detected in the environment within a field of view of the LIDAR sensor 112 may be processed (e.g., via one or more sensor and/or system processors, etc.) to generate a complete a view of an environment 200 around, or partially around, the vehicle 100. The LIDAR sensor 112 may be configured to generate changing views (e.g., approximately across 180 degrees in front, and along the sides, of the vehicle 100 when viewed from the plan view, etc.) of the environment 200 in real time (or near real time) for instance, as the vehicle 100 drives. In some cases, the LIDAR sensor 112 may have an effective detection limit 204 that is some distance from a center axis of the vehicle 100 outward over approximately 180 degrees. The effective detection limit 204 of the LIDAR sensor 112 defines a view zone 208 (e.g., an area and/or volume, etc.) surrounding at least a portion of the vehicle 100. Any object falling outside of the view zone 208 may be in the undetected zone 212 and would not be detected by the LIDAR sensor 112 of the vehicle 100 at a given point in time. Although shown disposed behind the laminate vehicle windshield 154, the LIDAR sensor 112 may be disposed behind one or more other laminate glass surfaces (e.g., side windows, quarter glass, rear window, sensor windows, etc.) of the vehicle 100. In some embodiments, the vehicle 100 may include number of LIDAR sensors 112 disposed in, and/or around, the vehicle 100 to provide a 360-degree view surrounding the vehicle 100. In any event, the composition and arrangement of the other laminate glass surfaces may be the same as, or substantially similar to, that of the laminate vehicle windshield 154 as described herein.

The LIDAR sensor 112 may include one or more components configured to measure distances to targets using laser illumination. In some embodiments, the LIDAR sensor 112 may provide 3D imaging data of an environment around the vehicle 100. The imaging data may be processed to generate at least a portion of a full 360-degree view of the environment around the vehicle 100. The LIDAR sensor 112 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LIDAR sensor 112 (e.g., through a portion of the laminate vehicle windshield 154, etc.) into a measurement environment. The rotating reflective surface may be configured to continually rotate 360 degrees about an axis, such that the plurality of laser beams is directed in outwardly from the vehicle 100 in a predetermined field of view. A photodiode receiver of the LIDAR sensor 112 may detect when light from the plurality of laser beams emitted into the measurement environment returns (e.g., reflected echo) to the LIDAR sensor 112. The LIDAR sensor 112 may calculate, based on a time associated with the emission of light to the detected return of light, a distance from the vehicle 100 to the illuminated target. In some embodiments, the LIDAR sensor 112 may generate over 2.0 million points per second and have an effective operational range of at least 100 meters. Examples of the LIDAR sensor 112 as described herein may include, but are not limited to, at least one of Velodyne® LiDAR™ HDL-64E 64-channel LIDAR sensors, Velodyne® LiDAR™ HDL-32E 32-channel LIDAR sensors, Velodyne® LiDAR™ PUCK™ VLP-16 16-channel LIDAR sensors, Leica Geosystems Pegasus: Two mobile sensor platform, Garmin® LIDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LIDAR sensors and/or systems, and may perform illuminated target and/or obstacle detection in an environment around the vehicle 100 using any known or future-developed standard and/or architecture.

Sensor data and information may be collected by one or more sensors or systems 116A-K, 112 of the vehicle 100 monitoring the vehicle sensing environment 200. This information may be processed (e.g., via a processor, computer-vision system, etc.) to determine targets (e.g., objects, signs, people, markings, roadways, conditions, etc.) inside one or more detection zones 208, 216A-D associated with the vehicle sensing environment 200. In some cases, information from multiple sensors 116A-K may be processed to form composite sensor detection information. For example, a first sensor 116A and a second sensor 116F may correspond to a first camera 116A and a second camera 116F aimed in a forward traveling direction of the vehicle 100. In this example, images collected by the cameras 116A, 116F may be combined to form stereo image information. This composite information may increase the capabilities of a single sensor in the one or more sensors 112, 116A-K by, for example, adding the ability to determine depth associated with targets in the one or more detection zones 204, 208, 216A-D. Similar image data may be collected by rear view sensors (e.g., LIDAR sensors 112, etc.) or cameras (e.g., sensors 116G, 116H) aimed in a rearward traveling direction vehicle 100 (e.g., facing in a direction running from the front 110 to the rear 120 of the vehicle 100, etc.).

In some embodiments, multiple sensors 116A-K may be effectively joined to increase a sensing zone and provide increased sensing coverage. For instance, multiple RADAR sensors 116B disposed on the front 110 of the vehicle may be joined to provide a zone 216B of coverage that spans across an entirety of the front 110 of the vehicle. In some cases, the multiple RADAR sensors 116B may cover a detection zone 216B that includes one or more other sensor detection zones 216A. These overlapping detection zones may provide redundant sensing, enhanced sensing, and/or provide greater detail in sensing within a particular portion (e.g., zone 216A) of a larger zone (e.g., zone 216B). Additionally or alternatively, the sensors 116A-K of the vehicle 100 may be arranged to create a complete coverage, via one or more sensing zones 208, 216A-D around the vehicle 100. In some areas, the sensing zones 216C of two or more sensors 116D, 116E may intersect at an overlap zone 220. In some areas, the angle and/or detection limit of two or more sensing zones 216C, 216D (e.g., of two or more sensors 116E, 116J, 116K) may meet at a virtual intersection point 224.

The vehicle 100 may include a number of sensors 116E, 116G, 116H, 116J, 116K disposed proximal to the rear 120 of the vehicle 100. These sensors can include, but are in no way limited to, an imaging sensor, camera, IR, LIDAR sensors, RADAR sensors, RF sensors, ultrasonic sensors, and/or other object-detection sensors. Among other things, these sensors 116E, 116G, 116H, 116J, 116K may detect targets near or approaching the rear of the vehicle 100. For example, another vehicle approaching the rear 120 of the vehicle 100 may be detected by one or more of the ranging and imaging systems (e.g., LIDAR sensor 112, etc.), rear-view cameras 116G, 116H, and/or rear facing RADAR sensors 116J, 116K. As described above, the images from the rear-view cameras 116G, 116H may be processed to generate a stereo view (e.g., providing depth associated with an object or environment, etc.) for targets visible to both cameras 116G, 116H. As another example, the vehicle 100 may be driving and one or more of the LIDAR sensor 112, front-facing cameras 116A, 116F, front-facing RADAR sensors 116B, and/or ultrasonic sensors 116C may detect targets in front of the vehicle 100. This approach may provide critical sensor information to a vehicle control system in at least one of the autonomous driving levels described above. For instance, when the vehicle 100 is driving autonomously (e.g., Level 3, Level 4, or Level 5) and detects other vehicles stopped in a travel path, the sensor detection information may be sent to the vehicle control system of the vehicle 100 to control a driving operation (e.g., braking, decelerating, etc.) associated with the vehicle 100 (in this example, slowing the vehicle 100 as to avoid colliding with the stopped other vehicles). As yet another example, the vehicle 100 may be operating and one or more of the LIDAR sensor 112, and/or the side-facing sensors 116D, 116E (e.g., RADAR, ultrasonic, camera, combinations thereof, and/or other type of sensor), may detect targets at a side of the vehicle 100. It should be appreciated that the sensors 116A-K may detect a target that is both at a side 160 and a front 110 of the vehicle 100 (e.g., disposed at a diagonal angle to a centerline of the vehicle 100 running from the front 110 of the vehicle 100 to the rear 120 of the vehicle). Additionally or alternatively, the sensors 112, 116A-K may detect a target that is both, or simultaneously, at a side 160 and a rear 120 of the vehicle 100 (e.g., disposed at a diagonal angle to the centerline of the vehicle 100).

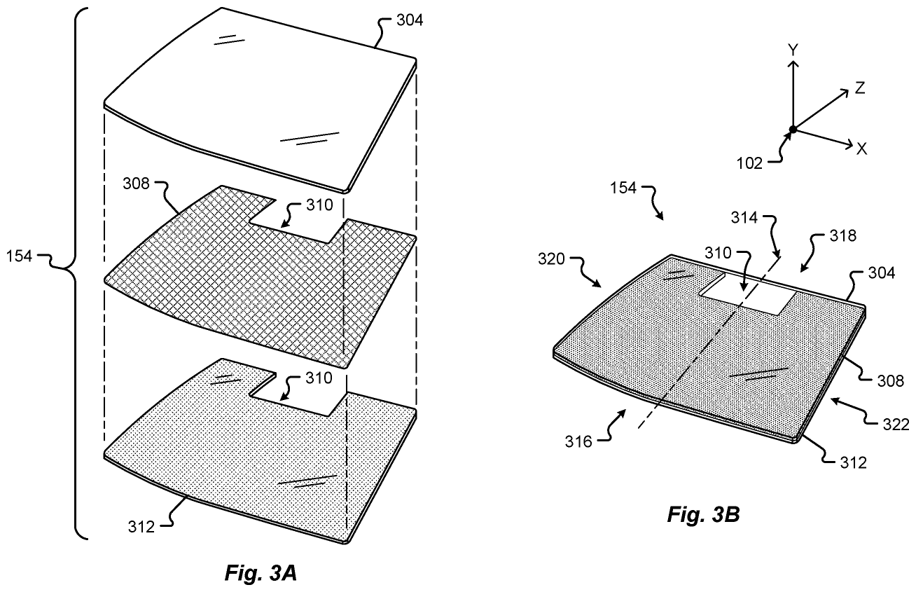

FIGS. 3A and 3B show various perspective views of the laminate vehicle windshield 154 in accordance with embodiments of the present disclosure. The laminate vehicle windshield 154 may comprise a first glass sheet 304 and a second glass sheet 312, which are bonded to one another via an interlayer 308. In some embodiments, the interlayer 308 may correspond to a polyvinyl butyral, or other optically clear bonding layer disposed between the first glass sheet 304 and the second glass sheet 312 layers of the laminate vehicle windshield 154. The interlayer 308 and/or the second glass sheet 312 may comprise a void area 310 disposed within an area of the laminate vehicle windshield 154. As shown in FIGS. 3A and 3B, the void area 310 is arranged as a notch, or cutout, disposed in the upper edge 318 of the laminate vehicle windshield 154. The void area 310 may correspond to a portion of material that has been removed from the interlayer 308 and/or the second glass sheet 312. In some embodiments, the void area 310 may correspond to an area of the interlayer 308 and/or the second glass sheet 312 that does not include material, for example, an empty space.

Referring to FIG. 3A, a perspective exploded view of an embodiment of a laminate vehicle windshield 154 is shown in accordance with embodiments of the present disclosure. The laminate vehicle windshield 154 may comprise a number of laminated layers 304, 308, 312, etc. of material forming the complete laminate vehicle windshield 154. Although shown as including three layers, the laminate vehicle windshield 154 may include a greater, or fewer, number of layers than are illustrated in FIGS. 3A and 3B. The first glass sheet 304 may correspond to an alkali-aluminosilicate, or equivalent, glass substrate. The alkali-aluminosilicate may be light permeable in a range of 900 nm to 1550 nm. This range may be tuned to a wavelength of light emitted from a LIDAR sensor 112 of the vehicle 100. Additionally or alternatively, the alkali-aluminosilicate substrate may comprise a scratch-resistant material having a Vickers hardness test rating in a range of 590 HV to 675 HV. The second glass sheet 312 may correspond to a low-iron soda-lime glass (e.g., Wideye glass manufactured by AGC Automotive, etc.). The interlayer 308 may correspond to a polyvinyl butyral resin or other optically-clear bonding/adhesive layer.

In contrast to standard laminated windshields, which may sandwich a polyvinyl butyral layer between identical layers of soda-lime glass, the laminate vehicle windshield 154 described herein may employ a LIDAR optically-tuned glass layer (e.g., first glass sheet 304) that is adhered to a low-iron soda-lime glass layer (e.g., second glass sheet 312) via the interlayer 308 and may further provide a void area 310 in the interlayer 308 and the second glass sheet 312 where only a portion of the first glass sheet 304 is arranged. In this arrangement, a LIDAR sensor 112 may be disposed in the interior 150 of the vehicle 100 behind the laminate vehicle windshield 154 and, more specifically, behind the void area 310, such that light emitted or received by the LIDAR sensor 112 only passes through the first glass sheet 304 (e.g., the alkali-aluminosilicate layer) of the laminate vehicle windshield 154.

FIG. 3B shows a perspective view of an embodiment of the laminate vehicle windshield 154 in accordance with embodiments of the present disclosure. When bonded, or otherwise adhered, together the first glass sheet 304, the interlayer 308, and the second glass sheet 312 may form the unified structure of the laminate vehicle windshield 154. Stated another way, when the sheets 304, 312 are bonded together, the laminate vehicle windshield 154 is a unified laminated structure. As shown in FIG. 3B, an area of the interlayer 308 and/or the second glass sheet 312 is missing from the laminate vehicle windshield 154. Among other things, this area, corresponding to the void area 310 shown in FIG. 3A, may provide an unobstructed path for light emitted and/or received by a LIDAR sensor 112, which is disposed behind the laminate vehicle windshield 154 in the interior 150 of the vehicle 100.

The laminate vehicle windshield 154 may comprise a lower edge 316, an upper edge 318, a left-side edge 320, and a right-side edge 322 disposed about a periphery of the laminate vehicle windshield 154. In some embodiments, the edges 316, 318, 320, 322 may be formed as linear, arcuate, or a combination of edge shapes or types, which are joined together (e.g., via radii, chamfers, corners, etc.) forming a periphery of the laminate vehicle windshield 154 and/or the first glass sheet 304. Although described as having a lower edge, an upper edge, a left-side edge, and a right-side edge, for example, when viewed from a vehicle front 110, it should be appreciated, that the sides, or edges, of the laminate vehicle windshield 154 may correspond to a first edge (e.g., lower edge 316), a second edge (e.g., upper edge 318), a third edge (e.g., left-side edge 320), and a fourth edge (e.g., right-side edge 322), respectively. In some embodiments, the laminate vehicle windshield 154 may be symmetrical about a windshield centerline 314. The windshield centerline 314 may pass through a center of the vehicle 100 (e.g., along the YZ-plane running through the center of the vehicle 100).

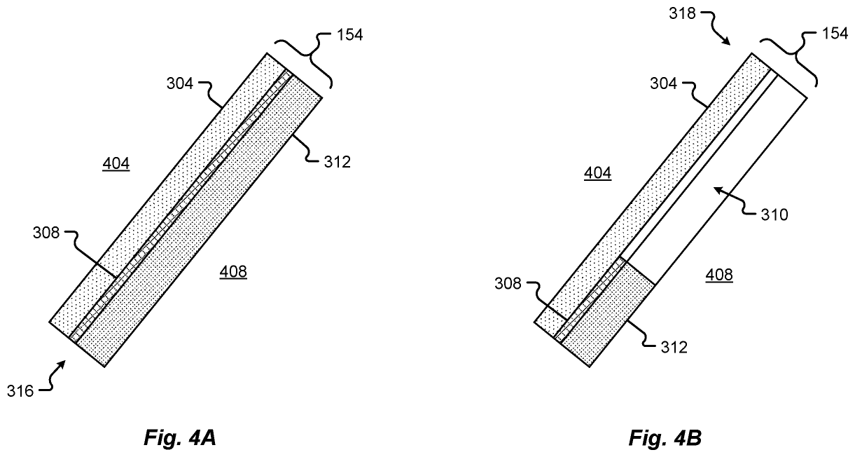

FIGS. 4A and 4B show partial detail section views of the laminate vehicle windshield 154 in the vehicle 100. In particular, FIG. 4A shows a partial detail section view, taken through line X-X of FIG. 2, of a first portion of the laminate vehicle windshield 154 in accordance with embodiments of the present disclosure. The partial detail section view of FIG. 4A is taken in a section of the laminate vehicle windshield 154 near, or adjacent to, a lower edge 316 of the laminate vehicle windshield 154 and the frame of the vehicle 100 surrounding the laminate vehicle windshield 154. As shown in FIG. 4A, the laminate vehicle windshield 154 may separate an exterior from an interior 150 of the vehicle 100. For example, the laminate vehicle windshield 154 may be arranged such that an outer windshield space 404 (e.g., exterior) is disposed on the left-hand side of the laminate vehicle windshield 154 (e.g., as shown in FIGS. 4A and 4B), while an inner windshield space 408 (e.g., interior 150) is disposed on the right-hand side of the laminate vehicle windshield 154. The laminate vehicle windshield 154 may be arranged, or otherwise mounted to the vehicle 100, such that the first glass sheet 304 is exposed to the outer windshield space 404 and the second glass sheet 312 is exposed only to the inner windshield space 408 (e.g., the interior 150 cabin of the vehicle 100).

In FIG. 4B, partial detail section view, taken through line X-X of FIG. 2, of a second portion of the laminate vehicle windshield 154 is shown in accordance with embodiments of the present disclosure. Specifically, FIG. 4B may illustrate a section that is taken through the laminate vehicle windshield 154 near, or adjacent to, an upper edge 318 of the laminate vehicle windshield 154 and the frame of the vehicle 100 surrounding the laminate vehicle windshield 154. As illustrated in FIG. 4B, the void area 310 provides a volume of the laminate vehicle windshield 154 where a portion of the second glass sheet 312 and/or the interlayer 308 does not exist, is not formed, or has been removed. In the void area 310, the first glass sheet 304 is exposed to both the outer windshield space 404 on one surface of the first glass sheet 304 and the inner windshield space 408 on the opposite surface of the first glass sheet 304.

The total thickness of the laminate vehicle windshield 154 may depend on a number of factors including, but in no way limited to, safety requirements, light transmission qualities, vehicle design, etc., and/or combinations thereof. In one embodiment, the total thickness of the laminate vehicle windshield 154, measured from the surface of the first glass sheet 304 adjacent to the outer windshield space 404 to the surface of the second glass sheet 312 adjacent to the inner windshield space 408, may be in a range of 1.7 mm to 7 mm thick, or any value in between the range. In some embodiments, the first glass sheet 304 may be in a range of 0.5 mm to 2.0 mm thick, the interlayer 308 may be in a range of 0.2 mm to 1.5 mm thick, and the second glass sheet 312 in a range of 1.0 mm to 3.5 mm thick, and/or any value therebetween. It should be appreciated that the thicknesses of the laminate vehicle windshield 154, and/or the thicknesses of the layers 304, 308, 312 of the laminate vehicle windshield 154 are not limited to the ranges provided and may be thinner or thicker than the values provided without departing from the scope of the disclosure.

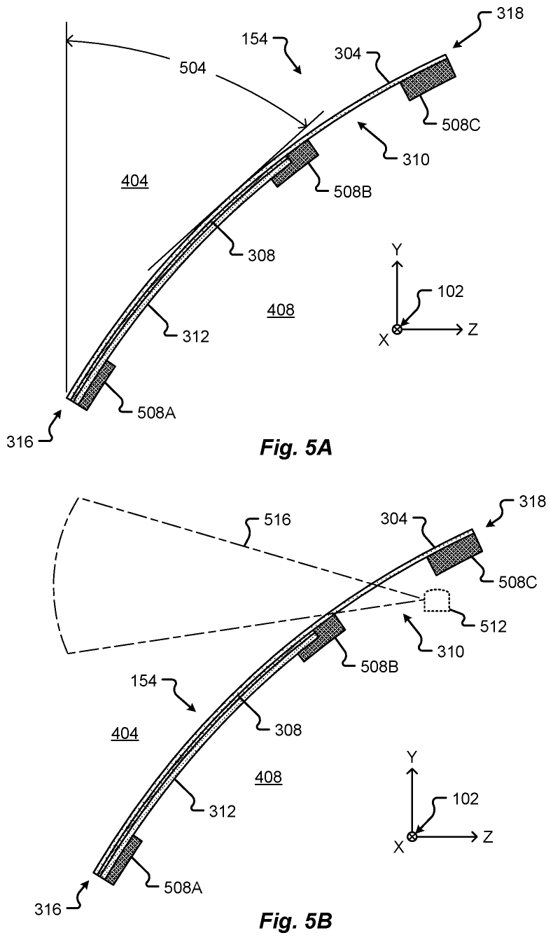

Referring now to FIG. 5A, a schematic section view, taken through line X-X of FIG. 2, of the laminate vehicle windshield 154 is shown in accordance with embodiments of the present disclosure. For the sake of clarity, the schematic section views shown in FIGS. 5A and 5B show the portions of the interlayer 308 and the second glass sheet 312 completely removed in the void area 310 of the laminate vehicle windshield 154. It should be appreciated that the void area 310 may extend a specific distance on either side of the windshield centerline 314 (e.g., in the X-axis direction shown in FIG. 3B). In any event, the laminate vehicle windshield 154 may be disposed at a rake angle, or windshield angle 504, which may be measured from vertical (e.g., the Y-axis). In some embodiments, the windshield angle 504 may be predetermined and set to allow for operational efficiency and aerodynamics of the vehicle 100. In one embodiment, the windshield angle 504 may be selected to provide a balanced optical transmission value for the LIDAR sensor 112 and aerodynamic angle for the laminate vehicle windshield 154 and vehicle 100. In one embodiment, the windshield angle 504 may be set in a range of 60 to 72 degrees, or any angle therebetween.

The laminate vehicle windshield 154 may be supported by one or more support structures 508A-508C. The support structures 508A-508C may correspond to points where the laminate vehicle windshield 154 is attached to the frame 104 of the vehicle 100. In some embodiments, the support structures 508A-508C may comprise a mechanical adhesive interface between the frame 104, or a portion of the frame 104 defining a frame for the laminate vehicle windshield 154, and the laminate vehicle windshield 154. In one embodiment, the support structures 508A-508C may define a frame for the laminate vehicle windshield 154. The frame for the laminate vehicle windshield 154 may be configured to support the laminate vehicle windshield 154 via adhesive contact (e.g., via a urethane adhesive material disposed between the laminate vehicle windshield 154 and the frame, etc.).

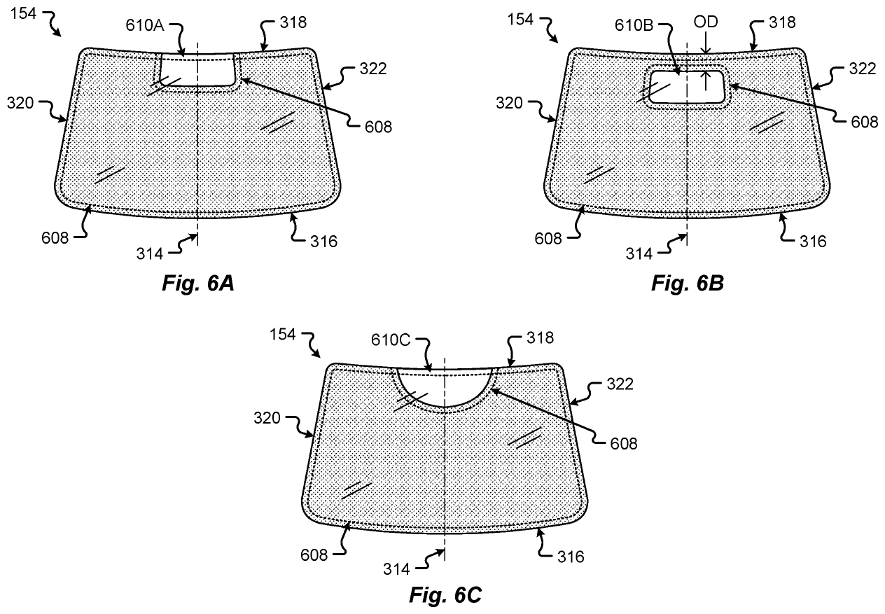

In some embodiments, the support structures 508A-508C may follow a periphery of the laminate vehicle windshield 154, the first glass sheet 304, and/or the void area 310. For example, the second support structure 508B and the third support structure 508C may surround the void area 310 disposed in the laminate vehicle windshield 154. In some embodiments, the second support structure 508B may connect with the third support structure 508C forming a continuous support frame for the laminate vehicle windshield 154. Additionally or alternatively, the first support structure 508A and the third support structure 508C may surround the laminate vehicle windshield 154 (e.g., following a periphery of the laminate vehicle windshield 154 and/or the first glass sheet 304, etc.). Additional details of the shape of the support structures 508A-508C are described in conjunction with FIGS. 6A-6C (e.g., windshield support structures 608).

FIG. 5B shows a schematic section view, taken through line X-X of FIG. 2, of the laminate vehicle windshield 154 with a sensor viewing position of a LIDAR sensor 112 in accordance with embodiments of the present disclosure. As described herein, the vehicle 100 may include a LIDAR sensor unit 512 disposed in the inner windshield space 408 (e.g., in the interior 150 of the vehicle 100) and configured to emit and receive light through the void area 310 of the laminate vehicle windshield 154. The LIDAR sensor unit 512 may include a LIDAR sensor 112, as previously described. As shown in FIG. 5B, the LIDAR sensor unit 512 is disposed behind the laminate vehicle windshield 154 (e.g., in the interior 150 cabin of the vehicle 100) and has a LIDAR field of view 516 through the first glass sheet 304 and extending into the outer windshield space 404 (e.g., the exterior of the vehicle 100). Stated another way, the light emitted from the LIDAR sensor unit 512 passes from a position inside the vehicle 100, through the void area 310 and the first glass sheet 304 (e.g., without passing through the interlayer 308 and/or the second glass sheet 312) before reaching a point in the outer windshield space 404. This LIDAR field of view 516 may correspond to the effective detection limit 204 of the LIDAR sensor 112 described in conjunction with FIG. 2. As can be appreciated, the LIDAR field of view 516 may comprise a volume, or space, defined by an operational detection range, R, from the LIDAR sensor unit 512, a vertical operational angle (e.g., in the YZ-plane), and a horizontal operational detection angle, a (e.g., in the XZ-plane).

FIGS. 6A-6C show various schematic plan views of void area shapes 610A-610C disposed behind a light permeable layer of the laminate vehicle windshield 154 in a vehicle windshield assembly. The construction of the laminate vehicle windshield 154 illustrated in FIGS. 6A-6C may be the same as, or similar to, the arrangement of layers (e.g., glass sheets 304, 312, interlayer 308, etc.) described above. Although not identified with reference characters in FIGS. 6A-6C, the first glass sheet 304 of the laminate vehicle windshield 154 is disposed in the foreground and the second glass sheet 312 is disposed in the background (e.g., behind the first glass sheet 304). The laminate vehicle windshields 154 shown in FIGS. 6A-6C, include an outline of the windshield support structure 608. The windshield support structure 608 may be the same as, or similar to, the support structures 508A-508C described in conjunction with FIGS. 5A-5B. In some embodiments, the windshield support structure 608 may follow a periphery of one or more features of the laminate vehicle windshield 154. For instance, the windshield support structure 608 may follow the periphery of the first glass sheet 304 and the periphery of the void area 610A-610C.

In some embodiments, the windshield support structure 608 may correspond to a material interface, adhesive contact, and/or frame between the laminate vehicle windshield 154 and the frame 104 of the vehicle 100. As shown in FIGS. 6A-6C, the windshield support structure 608 may contact the laminate vehicle windshield 154 at an area between the periphery of the first glass sheet 304 and a distance offset from the outermost periphery of the of the laminate vehicle windshield 154 (e.g., the line shown in dashed lines disposed inside the outermost periphery of the laminate vehicle windshield 154). This area may provide a support for the laminate vehicle windshield 154 along the edges of the laminate vehicle windshield 154. In addition, the vehicle windshield assembly may include a windshield support structure 608 that supports each void area 310, 610A-610C of the laminate vehicle windshield 154. The windshield support structure 608 may follow a periphery, or edge of the void area 310, 610A-610C providing an area of support between the periphery of the void area 310, 610A-610C and a distance offset from the void area 310, 610A-610C (e.g., shown as the dashed line offset outwardly from a center of each void area 610A-610C in FIGS. 6A-6C).

In any event, the windshield support structures 508A-C, 608 described herein may be made from a plastic, urethane, polyurethane, rubber, composites, etc., and/or other material. In some embodiments, the windshield support structures 508A-C, 608 may provide a compliant interface between the laminate vehicle windshield 154 and the frame 104 of the vehicle 100. Among other things, this compliant interface may provide shock absorbing characteristics for the laminate vehicle windshield 154, provide an even contact surface between the laminate vehicle windshield 154 and the frame 104 of the vehicle 100, and/or accommodate differences in coefficients of thermal expansion between the laminate vehicle windshield 154 and the frame 104 of the vehicle 100.

Referring to FIG. 6A, a schematic plan view of a first embodiment of a void area 610A disposed behind the light (e.g., LIDAR) permeable first glass sheet 304 of the vehicle windshield assembly is shown in accordance with embodiments of the present disclosure. As shown in FIG. 6A, the first void area 610A is arranged as a substantially rectangular cutout (e.g., in the interlayer 308 and/or the second glass sheet 312) of the laminate vehicle windshield 154. The first void area 610A does not penetrate or include the first glass sheet 304 of the laminate vehicle windshield 154, as described above. The substantially rectangular cutout may notch an edge of the periphery of the interlayer 308 and/or the second glass sheet 312. Additionally or alternatively, the shape of the first void area 610A may include a number of features to increase strength or prevent stress concentrations, fatigue failures, cracks, and/or the like. For instance, and as shown in FIG. 6A, the first void area 610A, arranged as a substantially rectangular cutout, may include radiused, arcuate, or curvilinear corners (e.g., where the “vertical” edges of the first void area 610A meet the “horizontal” edge of the first void area 610A when viewed in the plan view of FIG. 6A).

The windshield support structure 608 of FIG. 6A may surround an entirety of the laminate vehicle windshield 154. In some embodiments, the windshield support structure 608 may interconnect with and surround the periphery of the first void area 610A. The windshield support structure 608 may form a unified support for the various layers of the laminate vehicle windshield 154. In one embodiment, the windshield support structure 608 may contact a portion of the first glass sheet 304 and a portion of the second glass sheet 312. For instance, the windshield support structure 608 may contact a portion of the first glass sheet 304 in the first void area 610A along the upper edge 318 of the laminate vehicle windshield 154. In this case, the windshield support structure 608 may be thicker, or extended, in this area (e.g., providing an even support structure to the laminate vehicle windshield 154, etc.).

FIG. 6B shows a schematic plan view of a second embodiment of a void area 610B disposed behind a light (e.g., LIDAR) permeable first glass sheet 304 of the vehicle windshield assembly in accordance with embodiments of the present disclosure. As shown in FIG. 6B, the second void area 610B is arranged as a substantially rectangular cutout (e.g., in the interlayer 308 and/or the second glass sheet 312) of the laminate vehicle windshield 154. The second void area 610B does not penetrate or include the first glass sheet 304 of the laminate vehicle windshield 154, as described above. The substantially rectangular cutout may comprise at least four substantially linear edges. Stated another way, rather than notching an edge of the interlayer 308 and second glass sheet 312 like the first void area 610A, the second void area 610B may be an area where all of the edges are offset from an edge (e.g., the upper edge 318) of the laminate vehicle windshield 154. In this embodiment, the second void area 610B is offset from the upper edge 318 by an offset distance, OD, shown in FIG. 6B. Similar to the first void area 610A, the shape of the second void area 610B may include a number of features to increase strength or prevent stress concentrations, fatigue failures, cracks, and/or the like. For instance, and as shown in FIG. 6B, each of the four corners of the second void area 610B may include radiused, arcuate, or curvilinear corners (e.g., where the “vertical” edges of the second void area 610B meet the “horizontal” edges of the second void area 610B when viewed in the plan view of FIG. 6B).

The windshield support structure 608 of FIG. 6B may surround an entirety of the laminate vehicle windshield 154 and include a portion, separate or connected, that surrounds an entirety of the second void area 610B. The windshield support structure 608 may form a unified support for the various layers of the laminate vehicle windshield 154. As illustrated in FIG. 6B, the windshield support structure 608 may only contact a surface of the second glass sheet 312.

FIG. 6C shows a schematic plan view of a third embodiment of a void area 610C disposed behind a light (e.g., LIDAR) permeable first glass sheet 304 of the vehicle windshield assembly in accordance with embodiments of the present disclosure. As shown in FIG. 6C, the third void area 610C is arranged as an arcuate, curved, or semi-circular cutout (e.g., in the interlayer 308 and/or the second glass sheet 312) of the laminate vehicle windshield 154. The third void area 610C does not penetrate or include the first glass sheet 304 of the laminate vehicle windshield 154, as described above. Similar to the substantially rectangular cutout described in conjunction with FIG. 6A, the arcuate cutout of the third void area 610C may notch an edge of the periphery of the interlayer 308 and/or the second glass sheet 312.

The windshield support structure 608 of FIG. 6C may surround an entirety of the laminate vehicle windshield 154. In some embodiments, the windshield support structure 608 may interconnect with and surround the periphery of the third void area 610C. As provided above, the windshield support structure 608 may form a unified support for the various layers of the laminate vehicle windshield 154. In one embodiment, the windshield support structure 608 may contact a portion of the first glass sheet 304 and a portion of the second glass sheet 312. For instance, the windshield support structure 608 may contact a portion of the first glass sheet 304 in the third void area 610C along the upper edge 318 of the laminate vehicle windshield 154. In this case, the windshield support structure 608 may be thicker, or extended, in this area (e.g., providing an even support structure to the laminate vehicle windshield 154, etc.).

Although shown as arcuate and substantially rectangular shapes, it should be appreciated that the void area 310 of the laminate vehicle windshield 154 described herein may be of any shape, open or closed. For instance, any linear, curvilinear, or combination linear and curvilinear shape may be used to notch an edge (e.g., the upper edge 318, etc.) of the interlayer 308 and/or the second glass sheet 312 of laminate vehicle windshield 154 forming the void area 310. Additionally or alternatively, any polygonal, circular, elliptical, and/or combination shape may be removed, or not formed in, the interlayer 308 and/or the second glass sheet 312 to form the void area 310 of the laminate vehicle windshield 154.

In addition, the void areas 310, 610A-610C described herein may be shown as disposed adjacent to a particular edge (e.g., upper edge 318) of the laminate vehicle windshield 154 but embodiments of the present disclosure are not so limited. For instance, depending on the configuration of the laminate vehicle windshield 154 and/or the placement of the LIDAR sensor 112 or LIDAR sensor unit 512, the void areas 310, 610A-610C may be oriented in a center of the laminate vehicle windshield 154, adjacent to the lower edge 316, the left-side edge 320, and/or the right-side edge 322 of the laminate vehicle windshield 154.

The exemplary systems and methods of this disclosure have been described in relation to vehicle glass structures and vehicle windshields. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a laminate vehicle windshield, comprising: a first glass sheet; a second glass sheet disposed behind the first glass sheet; and an interlayer disposed between the first glass sheet and second glass sheet, wherein the first glass sheet and the second glass sheet are bonded together via adhesive contact with the interlayer; wherein the second glass sheet and the interlayer each include a void area disposed behind the first glass sheet and within a periphery of the first glass sheet.

Aspects of the above laminate vehicle windshield include wherein the first glass sheet comprises alkali-aluminosilicate, and wherein the second glass sheet comprises low iron soda-lime. Aspects of the above laminate vehicle windshield include wherein the first glass sheet is light permeable in a range of 900 nm to 1550 nm. Aspects of the above laminate vehicle windshield include wherein the interlayer comprises a polyvinyl butyral resin. Aspects of the above laminate vehicle windshield include wherein the first glass sheet is 0.5 mm to 2.0 mm thick, wherein the interlayer is 0.2 mm to 1.5 mm thick, and wherein the second glass sheet is 1.0 to 3.5 mm thick. Aspects of the above laminate vehicle windshield include wherein the void area is arranged as a substantially rectangular cutout in the second glass sheet and the interlayer. Aspects of the above laminate vehicle windshield include wherein the substantially rectangular cutout notches an edge of a periphery of the second glass sheet and the interlayer. Aspects of the above laminate vehicle windshield include wherein the substantially rectangular cutout comprises at least four substantially linear edges, and wherein each of the at least four substantially linear edges of the substantially rectangular cutout is offset from an adjacent edge of the second glass sheet and the interlayer.

Embodiments include a vehicle windshield assembly, comprising: a laminate vehicle windshield, comprising: a first glass sheet; a second glass sheet disposed behind the first glass sheet; and an interlayer disposed between the first glass sheet and second glass sheet, wherein the first glass sheet and the second glass sheet are bonded together via adhesive contact with the interlayer; wherein the second glass sheet and the interlayer each include a void area disposed behind the first glass sheet and within a periphery of the first glass sheet; and a support structure surrounding the periphery of the first glass sheet and following a periphery of the void area in the second glass sheet and the interlayer, wherein the support structure comprises a mechanical frame to which the laminate vehicle windshield is attached.

Aspects of the above vehicle windshield assembly include wherein the first glass sheet comprises alkali-aluminosilicate, and wherein the second glass sheet comprises low iron soda-lime. Aspects of the above vehicle windshield assembly include wherein the first glass sheet is light permeable in a range of 900 nm to 1550 nm. Aspects of the above vehicle windshield assembly include wherein the interlayer comprises a polyvinyl butyral resin. Aspects of the above vehicle windshield assembly include wherein the first glass sheet is 0.5 mm to 2.0 mm thick, wherein the interlayer is 0.2 mm to 1.5 mm thick, and wherein the second glass sheet is 1.0 to 3.5 mm thick. Aspects of the above vehicle windshield assembly include wherein the void area is arranged as a substantially rectangular cutout in the second glass sheet and the interlayer, and wherein a portion of the support structure surrounds at least three sides of the substantially rectangular cutout. Aspects of the above vehicle windshield assembly include wherein the substantially rectangular cutout notches an edge of a periphery of the second glass sheet and the interlayer. Aspects of the above vehicle windshield assembly include wherein the substantially rectangular cutout comprises at least four substantially linear edges, and wherein each of the at least four substantially linear edges of the substantially rectangular cutout is offset from an adjacent edge of the second glass sheet and the interlayer. Aspects of the above vehicle windshield assembly include wherein a urethane adhesive material is disposed between the second glass sheet and the support structure attaching the laminate vehicle windshield to the support structure.

Embodiments include a vehicle, comprising: a vehicle chassis comprising a windshield frame defining a mount periphery for a windshield; a laminate vehicle windshield disposed in the windshield frame of the vehicle chassis, the laminate vehicle windshield comprising: a first glass sheet; a second glass sheet disposed behind the first glass sheet; and an interlayer disposed between the first glass sheet and second glass sheet, wherein the first glass sheet and the second glass sheet are bonded together via adhesive contact with the interlayer; wherein the second glass sheet and the interlayer each include a void area disposed behind the first glass sheet and within a periphery of the first glass sheet; and a support structure surrounding the periphery of the first glass sheet and following a periphery of the void area in the second glass sheet and the interlayer, wherein the support structure comprises a mechanical adhesive interface between the windshield frame and the laminate vehicle windshield, and wherein the laminate vehicle windshield separates an interior cabin of the vehicle from an exterior of the vehicle.

Aspects of the above vehicle further comprise a light imaging detection and ranging (LIDAR) sensor disposed inside the cabin of the vehicle, wherein the LIDAR sensor is arranged behind the first glass sheet, and wherein a path defining a field of view of the LIDAR sensor passes through the first glass sheet from the inside of the cabin of the vehicle to the exterior of the vehicle without passing through the second glass sheet in the void area. Aspects of the above vehicle further comprise wherein the first glass sheet comprises alkali-aluminosilicate that is light permeable in a range of 900 nm to 1550 nm, wherein the second glass sheet comprises low iron soda-lime, and wherein the interlayer comprises a polyvinyl butyral resin.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A laminate vehicle windshield, comprising:
a first glass sheet;
a second glass sheet disposed behind the first glass sheet; and
an interlayer disposed between the first glass sheet and second glass sheet, wherein the first glass sheet and the second glass sheet are bonded together via adhesive contact with the interlayer;
wherein the second glass sheet and the interlayer each include a void area disposed behind the first glass sheet and within a periphery of the first glass sheet.

2. The laminate vehicle windshield of claim 1, wherein the first glass sheet comprises alkali-aluminosilicate, and wherein the second glass sheet comprises low iron soda-lime.

3. The laminate vehicle windshield of claim 2, wherein the first glass sheet is light permeable in a range of 900 nm to 1550 nm.

4. The laminate vehicle windshield of claim 3, wherein the interlayer comprises a polyvinyl butyral resin.

5. The laminate vehicle windshield of claim 3, wherein the first glass sheet is 0.5 mm to 2.0 mm thick, wherein the interlayer is 0.2 mm to 1.5 mm thick, and wherein the second glass sheet is 1.0 to 3.5 mm thick.

6. The laminate vehicle windshield of claim 4, wherein the void area is arranged as a substantially rectangular cutout in the second glass sheet and the interlayer.

7. The laminate vehicle windshield of claim 6, wherein the substantially rectangular cutout notches an edge of a periphery of the second glass sheet and the interlayer.

8. The laminate vehicle windshield of claim 6, wherein the substantially rectangular cutout comprises at least four substantially linear edges, and wherein each of the at least four substantially linear edges of the substantially rectangular cutout is offset from an adjacent edge of the second glass sheet and the interlayer.

9. A vehicle windshield assembly, comprising:
a laminate vehicle windshield, comprising:
a first glass sheet;
a second glass sheet disposed behind the first glass sheet; and
an interlayer disposed between the first glass sheet and second glass sheet, wherein the first glass sheet and the second glass sheet are bonded together via adhesive contact with the interlayer;
wherein the second glass sheet and the interlayer each include a void area disposed behind the first glass sheet and within a periphery of the first glass sheet; and
a support structure surrounding the periphery of the first glass sheet and following a periphery of the void area in the second glass sheet and the interlayer, wherein the support structure comprises a mechanical frame to which the laminate vehicle windshield is attached.

10. The vehicle windshield assembly of claim 9, wherein the first glass sheet comprises alkali-aluminosilicate, and wherein the second glass sheet comprises low iron soda-lime.

11. The vehicle windshield assembly of claim 10, wherein the first glass sheet is light permeable in a range of 900 nm to 1550 nm.

12. The vehicle windshield assembly of claim 11, wherein the interlayer comprises a polyvinyl butyral resin.

13. The vehicle windshield assembly of claim 11, wherein the first glass sheet is 0.5 mm to 2.0 mm thick, wherein the interlayer is 0.2 mm to 1.5 mm thick, and wherein the second glass sheet is 1.0 to 3.5 mm thick.

14. The vehicle windshield assembly of claim 12, wherein the void area is arranged as a substantially rectangular cutout in the second glass sheet and the interlayer, and wherein a portion of the support structure surrounds at least three sides of the substantially rectangular cutout.

15. The vehicle windshield assembly of claim 14, wherein the substantially rectangular cutout notches an edge of a periphery of the second glass sheet and the interlayer.

16. The vehicle windshield assembly of claim 14, wherein the substantially rectangular cutout comprises at least four substantially linear edges, and wherein each of the at least four substantially linear edges of the substantially rectangular cutout is offset from an adjacent edge of the second glass sheet and the interlayer.

17. The vehicle windshield assembly of claim 14, wherein a urethane adhesive material is disposed between the second glass sheet and the support structure attaching the laminate vehicle windshield to the support structure.

18. A vehicle, comprising:
a vehicle chassis comprising a windshield frame defining a mount periphery for a windshield;
a laminate vehicle windshield disposed in the windshield frame of the vehicle chassis, the laminate vehicle windshield comprising:
a first glass sheet;
a second glass sheet disposed behind the first glass sheet; and
an interlayer disposed between the first glass sheet and second glass sheet, wherein the first glass sheet and the second glass sheet are bonded together via adhesive contact with the interlayer;
wherein the second glass sheet and the interlayer each include a void area disposed behind the first glass sheet and within a periphery of the first glass sheet; and
a support structure surrounding the periphery of the first glass sheet and following a periphery of the void area in the second glass sheet and the interlayer, wherein the support structure comprises a mechanical adhesive interface between the windshield frame and the laminate vehicle windshield, and wherein the laminate vehicle windshield separates an interior cabin of the vehicle from an exterior of the vehicle.

19. The vehicle of claim 18, further comprising:
a light imaging detection and ranging (LIDAR) sensor disposed inside the cabin of the vehicle, wherein the LIDAR sensor is arranged behind the first glass sheet, and wherein a path defining a field of view of the LIDAR sensor passes through the first glass sheet from the inside of the cabin of the vehicle to the exterior of the vehicle without passing through the second glass sheet in the void area.

20. The vehicle of claim 19, wherein the first glass sheet comprises alkali-aluminosilicate that is light permeable in a range of 900 nm to 1550 nm, wherein the second glass sheet comprises low iron soda-lime, and wherein the interlayer comprises a polyvinyl butyral resin.
